(19) United States
(12) Patent Application Publication
(10) Pub. No.: US 2002/0153178 A1
(43) Pub. Date: Oct. 24, 2002

(54) Regenerative electric vehicle

(76) Inventor: Paul Limonius, Tampa, FL (US)

Correspondence Address: Michael I. Kroll, 171 Stillwell Lane, Syosset, NY, 11791, US

(21) Appl. No.: 09/840,217

(22) Filed: Apr. 23, 2001

(51) Int. Cl. B60L 8/00

(52) U.S. Cl. 180/2.2; 180/165; 180/65.1

(57) ABSTRACT

The present invention 10 discloses an automobile having an electric motor 30 along with various means of regenerating auxiliary power for the vehicle. Multiple auxiliary generation means are disclosed including wind generators 26, steam turbines 46, wheel generators 22, brake activated generators 44, and solar t-tops 16. The wind generators are incorporated internal the air duct 24 which passes entirely through the automobile having either roll cage generators 26 or fan type impellers 78 and including means for the air to cool motor 30. Wheel generators 22 are disclosed which may operate off the hubs 22 or have an alternate generator position 28 which places a rotor head in communication with the wheel/tire 34. A steam turbine 46 is disclosed having means to fire 60 a boiler wherein steam 64 is generated which steam drives the steam turbine 46 which in turn has means 66 for driving the generators 68 and thereafter the steam is condensed and recycled through conduit 54 back into the boiler 58. The solar panel t-tops 16 comprise solar membranes 75 which are embedded in the t-tops. Alternatively, an air duct intake port can be tubular shaped 76 instead of rectangular shaped. Also disclosed is an alternative embodiment wherein dual wind turbine generators 25 are incorporated into the down draft system of a Formula 1 racing car.

### BACKGROUND OF THE INVENTION

1. Field of the Invention

The present invention relates generally to electric vehicles and, more specifically, to an electric vehicle which utilizes a plurality of regeneration systems to harness the potential kinetic energy of the moving vehicle and the elements surrounding it to supply supplemental power to the vehicle's battery banks thereby effectively extending the range and speed the vehicle can travel between charges. The regenerative electric vehicle is also more efficient due the reduced aerodynamic drag and lighter weight of the vehicle attributed to a wind tunnel that extends centrally from the front of the vehicle to the back to house air driven impellers for the wind-powered generators. Air traveling through the wind tunnel is used to cool the electric engine to further increase efficiency.

2. Description of the Prior Art

There are other electric vehicles designed for regenerating electricity. Typical of these is U.S. Pat. No. 4,075,545 issued to Merle D. Haberer on Feb. 21, 1978.

Another patent was issued to Herbert W. Biggs on Jun. 13, 1978 as U.S. Pat. No. 4,094,377.

Yet another U.S. Pat. No. 4,132,282 was issued to Keith L. Sparks on Jan. 2, 1979 and still yet another was issued on Feb. 27, 1979 to Russell T. Treat as U.S. Pat. No. 4,141,425.

Another patent was issued to James M. Travis on Jan. 2, 1981 as U.S. Pat. No. 4,270,622. Yet another U.S. Pat. No. 4,578,955 was issued to Ralph Medina on Apr. 1, 1986. Another was issued to Elmer W. Gardiner on May 2, 1989 as U.S. Pat. No. 4,825,656 and still yet another was issued on Jun. 1, 1993 to Nathan Stulbach et al. as U.S. Pat. No. 5,215,156. Still another patent was issued to Cletus L. Taylor et al. on Jan. 25, 1994 as U.S. Pat. No. 5,280,827 and yet another patent was issued on May 5, 1998 to Everett W. Brighton as U.S. Pat. No. 5,746,283.

### U.S. Pat. No. 4,075,545

### Inventor: Merle D. Haberer

### Issued: Feb. 21, 1978

A pair of air driven impeller rotors mounted in the front-end portion of a vehicle and operatively connected to one or more generators for charging drive motor energizing batteries responsive to forward movement of the vehicle. The impeller rotors are disposed in radially spaced parallel relationship to provide an air passageway therebetween, each rotor including a cylindrical drum and vanes projecting outwardly from the drum. The impeller rotors operate to rotate the generator field of pole pieces in one direction and the generator armature or armatures in the opposite direction. Guide structure includes a pair of cross-sectionally arcuate guide portions which cooperate with the impeller to define discharge passageways extending generally circumferentially of the impeller rotors.

### U.S. Pat. No. 4,075,545

### Inventor: Herbert W. Biggs

### Issued: Jun. 13, 1978

A battery powered drive system for vehicles comprising a pair of electrical storage batteries designed to be connected alternately to electric motor which propels the vehicle. A steam engine having a shaft drives a generator also designed to be alternately connected to the storage batteries for recharging, and a steam boiler supplies the steam engine and itself receives energy either from a solar heater, burner or electrical heaters provided for that purpose.

### U.S. Pat. No. 4,132,282

### Inventor: Keith L. Sparks

### Issued: Jan. 2, 1979

The present invention provides an arrangement for the use of a battery powered automotive vehicle and more particularly provides a means utilizing wind currents for generation of electric power, for use in connection with an electric motor driven vehicle, including: rotatable impeller means responsive to flow of air and mounted for rotation about a vertical axis where the impeller is carried on the surface of the electric motor driven vehicle; a power shaft cooperatively connecting an electric generator means and the impeller for generation of electric energy to be supplied to an electric storage battery means; and an electric motor to drive the vehicle; air guide means to direct streams to the impeller to optimize efficiency in rotation of the impeller in one direction when the vehicle is proceeding in a selected direction and rotation of the impeller when the vehicle is at rest.

### U.S. Pat. No. 4,141,425

### Inventor: Russell T. Treat

### Issued: Feb. 27, 1979

Apparatus for generating electrical energy useful for powering of the electrical apparatuses associated with the operations of a vehicle, boat, residence, or other structure, including a bank of batteries associated with one of said structures and provided for furnishing the electrical energy necessary for its operations, an electrical energy producing solar panel operatively disposed with the structure for creating electrical energy for recharging of its bank of batteries, and, an impeller driven alternator, the impeller being rotated through the efforts of air passing thereby, providing also for selectively recharging of the bank of batteries of one of the identified structures. In the preferred instance, the structure comprises an electric powered vehicle, incorporating front and rear wheels, with a variable speed direct current electrical motor associated with the said wheels, gearing interconnected between the motor and the wheels, with the solar panel or alternator charged batteries conducting the electrical energy to the motor to attain its revolving and the consequent rotation of the vehicle wheels for inducing movement.

### U.S. Pat. No. 4,270,622

### Inventor: James M. Travis

### Issued: Jun. 2, 1981

An electric powered vehicle drive axle is disclosed. The axle of the present invention comprises a ring gear; a first pinion gear for rotating ring gear; a differential carried by the ring gear; a pair of axle shafts driven by the differential for rotatably driving a pair of drive wheels; the device supported and enclosed by a housing. A second pinion gear is employed which rotatably engages the ring gear. A first electric motor rotatably connected to the first pinion gear is connected to a power source for rotatably driving the vehicle. An electric motor/generator is connected to the second pinion gear and electrically connected to the power source. The second electric motor/generator selectively powers the differential or derives power from the differential to recharge the power source as dictated by the power needs of the electric vehicle. A plurality of bevel gears is deployed along the length of the axles. Each bevel gear is rotatably connected to a pair of opposed bevel gears, each opposed gear is rotatably connected to an electric motor/generator. By selectively and electrically causing the plurality of motors/generators to either power the axle or be powered by the axle optimum efficiency and recharging of the battery over a range of vehicle operating is obtained.

### U.S. Pat. No. 4,578,955

### Inventor: Ralph Medina

### Issued: Apr. 1, 1986

In an automotive power plant including an electric motor having a drive shaft connected to a transmission and a battery pack connected to the motor for vehicle speeds up to 30 miles per hour approximately, the improvement comprising an alternate power source including an electric generator connectable to the drive shaft having output leads connected to the battery pack and to the motor. An air compressor a drive shaft is coupled to the motor drive shaft and has an air outlet connected to a reservoir. A boost pump is connected to the reservoir or air compressor to a combustion chamber having an electric ignition and a connection to a pressurized fuel source and includes a high velocity exhaust gas outlet. A turbine receives exhaust gases for driving an impeller secured upon the compressor shaft.

### U.S. Pat. No. 4,825,656

### Inventor: Elmer W. Gardiner Jr.

### Issued: May 2, 1989

A vehicle drive system in which batteries provide power for driving an electric motor connected to a pump for either compressing air or pressurizing hydraulic fluid for loading a fluid cylinder that is operatively connected for reciprocatably driving a series of drive gears connected to and for providing rotation to a series of worm gears having an output shaft connected for driving the wheels of a vehicle. A kinetic energy recovery system in which a series of gravitational alternators are operably connected between the axle and chassis/frame of a vehicle for providing electricity during vehicular movement. Additional kinetic energy is recovered as steam is generated by deriving heat from the operative fluid cylinder to the screw engine and transmitting the heated fluid to a low-pressure steam boiler for providing steam in operating a screw engine generator for generating electricity.

### U.S. Pat. No. 5,215,156

### Inventor: Nathan Stulbach et al.

### Issued: Jun. 1, 1993

A vehicle having an Electro-generating system which includes a dynamoelectric generator. The shaft of the dynamoelectric generator is linked directly or indirectly with the rotating axle of the road wheels of the vehicle, preferably via a mechanical turns amplifier. The turns amplifier will multiply the rotation rate of the Electro-generating system and increase the production capacity of electric power. The dynamoelectric generator can be utilized to recharge a storage battery driving the vehicle while the car is in motion, especially automatically when the vehicle is going down hill. The vehicle's electric motor can be driven directly from a dynamoelectric generator in place of a storage battery after the vehicle is moving. In railroad cars (freight and passenger) the Electro-generating system can be utilized to charge storage batteries, with their electricity utilized for other Electro-energy requirements.

### U.S. Pat. No. 5,280,827

### Inventor: Cletus L. Taylor

### Issued: Jan. 25, 1994

An electric motor-driven vehicle has a large wind turbine mounted at the rear of the vehicle that rotates about an axis perpendicular to the axis of the vehicle body. A long venturi tube extends along the upper portion of the vehicle above the passenger cab and directs airflow from the front of the vehicle and impinges it upon an upper portion of the turbine blades. A pair of elongated lower screw-type turbines are contained in separate lower venturi effect tubes extending along the lower side of the vehicle below the passenger cab. Air from the lower venturi effect tubes is impinged upon the large turbine in a direction and at a location to increase the force generated from the upper venturi tube. The turbines drive one or more electric power generators coupled to storage batteries for recharging the batteries.

### U.S. Pat. No. 5,746,283

### Inventor: Everett W. Brighton

### Issued: May 5, 1998

A system using a stored power unit, such as a battery pack, to supply electric current for driving an electric motor-driven generator, which in turn, drives a propulsion motor drive system. The propulsion motor drive system uses either one, two or several electric propulsion to propel a vehicle. The system has a control device that diverts power from the generator output to the stored power unit to recharge and maintain the stored power unit when operating permit. Amorphous energy sources, such as a wind turbine that is mounted on the vehicles roof, for example, can also supply recharging power. By use of strict energy control, the vehicle may be operated over many miles without having to recharge the batteries from a utility power source.

### SUMMARY OF THE PRESENT INVENTION

The present invention discloses an automobile having an electric motor along with various means of regenerating auxiliary power for the vehicle. Multiple auxiliary generation means are disclosed including wind generators, steam turbines, wheel generators, brake activated generators, and solar t-tops. The wind generators are incorporated internal the air duct which passes entirely through the automobile having either roll cage generators or fan type impellers and including means for the air to cool the motor. Wheel generators are disclosed which may operate off the hubs or have an alternate generator position which places a rotor head in communication with the wheel/tire. A steam turbine is disclosed having means to fire a boiler wherein steam is generated which steam drives the steam turbine which in turn has means for driving the generators and thereafter the steam is condensed and recycled through a conduit back into the boiler. The solar panel t-tops comprise solar membranes which are embedded in the t-tops. Alternatively, an air duct intake port can be tubular shaped instead of rectangular shaped. Also disclosed is an alternative embodiment wherein dual wind turbine generators are incorporated into the down draft system of a Formula 1 racing car.

A primary object of the present invention is to provide an electric vehicle having a plurality of regenerative systems to provide supplemental charges to the battery banks for storage or to assist in powering the vehicle thereby significantly increasing the range and speed capabilities of said vehicle between standard A/C recharges and reducing the time and power needed to completely recharge the batteries.

A further primary object of the present invention is to provide a regenerative electric vehicle that utilizes the wind currents created by vehicular movement to regenerate electricity by channeling the ensuing headwind into an air intake port located in front of the vehicle and into a wind tunnel extending through the entirety of the vehicle to an exhaust port in the rear of said vehicle. A plurality of air driven impellers act upon electrical generators situated within the wind tunnel and rotate to power said generators as the forced air travels therethrough.

Another object of the present invention is to provide a regenerative electric vehicle wherein the configuration of the wind tunnel is determined by the type of air driven impeller used, i.e. a round fan-type impeller would require a tubular duct whereas a rollcage-type impeller would require a rectangular duct.

Still another object of the present invention is to provide a regenerative electric vehicle having generators slaved to each of the vehicle's wheels and cooperating with either the rotational hubs or directly with the tires in order to harness the potential energy of the rotational force of each wheel.

Yet another object of the present invention is to provide a regenerative electric vehicle having a retractable sunroof or t-tops wherein a solar membrane is imbedded within the glass thereby providing a passive regeneration system that under the proper conditions will continue to provide a charge to the battery banks even when the vehicle is not in operation.

A further object of the present invention is to provide a regenerative electric vehicle having an electric regeneration system integrated within the braking system of the vehicle wherein generator clock assemblies are located on either side of the motor package and make contact with the axle assembly through the use of a disc/clutch type system. Application of the vehicle's braking system to slow or stop the vehicle cause the generator clocks to get wound-up from the spinning motion of the axles. The generator clocks release and unwind once the vehicle is at rest for a specified time causing the attached generators to provide a charge to the battery banks.

A still further object of the present invention is to provide a regenerative source to the electric vehicle by having an emergency generation system to operate the vehicle during low or dead battery conditions by utilizing a steam turbine that when activated acts upon the generators tied to the generator clock mechanisms to provide an alternate source of electrical power wherein propane and a spark ignition are used to initiate the steam to drive the turbine.

A yet further object of the present invention is to provide a regenerative electric vehicle wherein the wind tunnel is configured to reinforce the strength of the vehicle's body while reducing the vehicular weight since it is relatively hollow.

Another object of the present invention is to provide a regenerative electric vehicle wherein the wind tunnel increases the efficiency and performance of the present invention by reducing drag caused by air currents placed against the front of the vehicle and by acting as a spoiler as those air currents pass therethrough where they also are used to help cool the engine.

Additional objects of the present invention will appear as the description proceeds.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of the present invention in use.

FIG. 2 is a perspective view of the present invention in use. Shown is air entering the air intake port where it will turn the impellers inside the wind tunnel thereby driving the generators. The air passing through the wind tunnel is used to cool the engine. Also shown are solar panel t-tops which are collecting and converting the potential energy of the suns rays to electricity.

FIG. 3 is a side view of the present invention showing the wind generator system.

FIG. 4 is a perspective view of the wind generator system of the present invention illustrating the components and their interaction with one another.

FIG. 5 is a diagrammatic top view of the present invention illustrating the placement of the wheel generators, wind generators, generator clocks, the electrical motor and the emergency steam turbine generator.

FIG. 6 is a diagrammatic side view of the present invention illustrating the placement of the battery banks and the wind generator system.

FIG. 7 is a diagrammatic side view of the steam turbine generator system.

FIG. 8 is a top and side view of the present invention showing the solar panel t-tops.

FIG. 9 is a perspective view of the present invention having a tubular wind tunnel to house round fan-type impellers.

FIG. 10 is a diagrammatic bottom view of the present invention showing a plurality of fan-type impellers inside a tubular duct.

FIG. 11 is a top view of the present invention installed in a formula 1 race car using a dual duct roll-cage system.

FIG. 12 is a top view of the present invention installed in a formula 1 race car using a dual duct roll-cage system.

### LIST OF REFERENCE NUMERALS

With regard to reference numerals used, the following numbering is used throughout the drawings.

10 present invention

12 air

14 air intake port

16 solar t-tops

18 sun rays

20 steam turbine engine

22 wheel generator hubs

24 wind tunnel

25 wind generator

26 roll cage wind generators

28 alternate wheel generator position

30 motor

32 air outlet port

34 wheels/tire

36 rectangular duct

38 wind generator housing

40 rotary head

42 brake activated generator clock

44 brake activated generator

46 steam turbine

48 batteries

49 water tank

50 propane

52 turbine generator system

54 conduit

56 boiler

58 water

60 flame/heat

62 igniter

64 steam

66 connection means

68 steam generator

70 relief valve

72 check valve

74 condenser coil

75 solar membrane

76 tubular air duct

78 fan-type impeller

### DESCRIPTION OF THE PREFERRED EMBODIMENT(S)

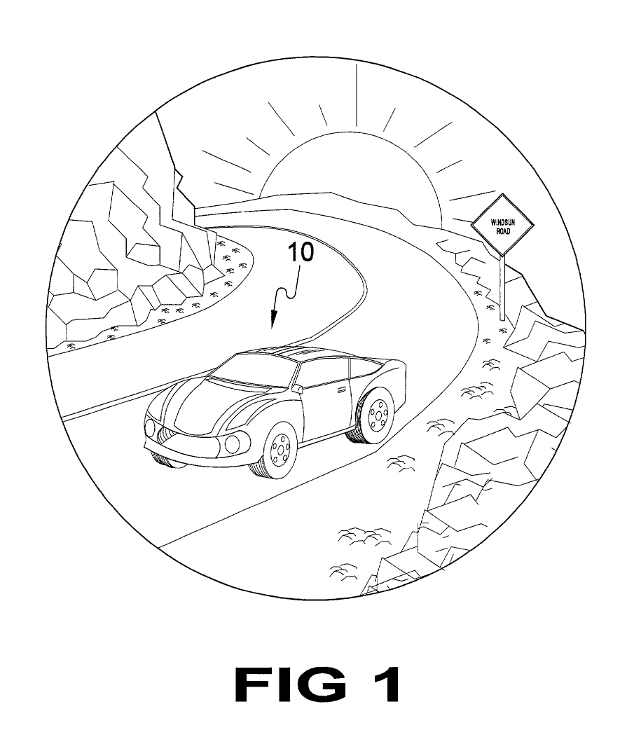

In order that the invention may be more fully understood, it will now be described, by way of example, with reference to the accompanying drawings in which FIGS. 1 through 12 illustrate the present invention being a regenerative electric vehicle.

Turning to FIG. 1, shown therein is a perspective view of the present invention 10 in use. Shown therein is a high performance, electrical automobile comprising a wind turbine, a solar power feature, wheel generators and a steam turbine for turning emergency/auxiliary generators in the event of low battery level.

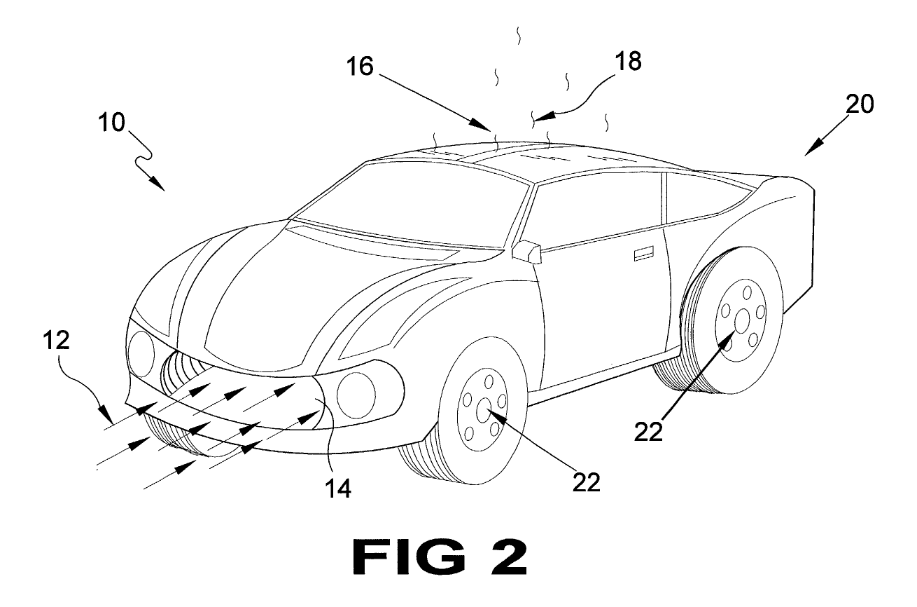

Turning to FIG. 2, shown therein is a perspective view of the present invention 10 in use being a high performance, long range electric automobile. Shown is air 12 entering the ram air intake port 14 where it will turn the impellers inside the wind tunnel thereby driving the wind generators. The air passing through the wind tunnel is also used to cool the electric engine. Also shown are solar panel t-tops 16 which collect and convert the potential energy of the suns rays 18 to electricity. Also indicated are a steam turbine engine 20 and wheel generator hubs 22.

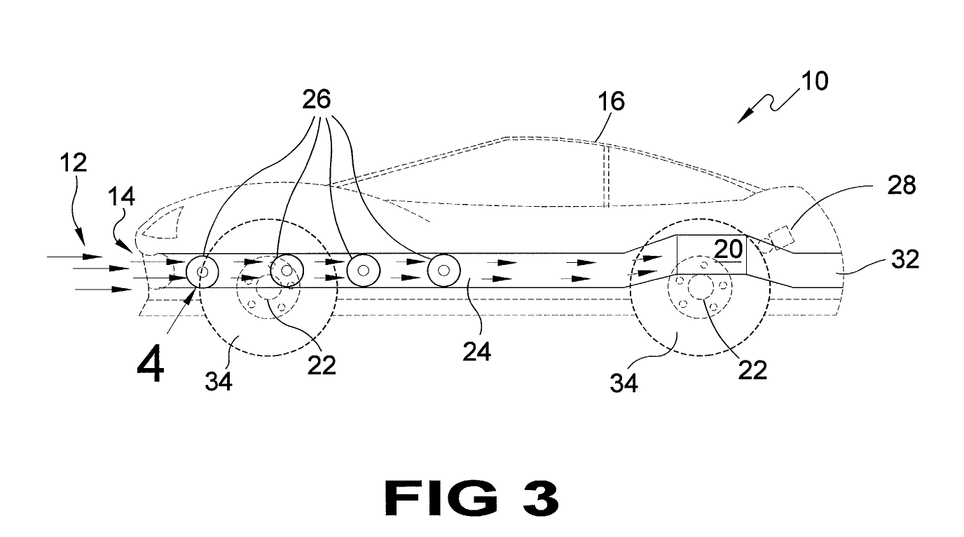

Turning to FIG. 3, shown therein is a side view of the present invention 10 showing the wind generator system. Shown therein is the ram air flow 12 entering the air intake port 14 where it turns a roll cage type wind generator 26 inside the wind tunnel 24 which wind tunnel extends entirely through the length of the vehicle having an outlet 32. Also shown is the alternate wheel generator position in communication with the wheels/tires 34. Also shown is an electric motor 30 located within the wind tunnel which motor 30 is cooled inside the wind tunnel 24 by the air passing through the wind tunnel. Also shown are the solar t-tops 16 and the wheel generators 22 as previously disclosed.

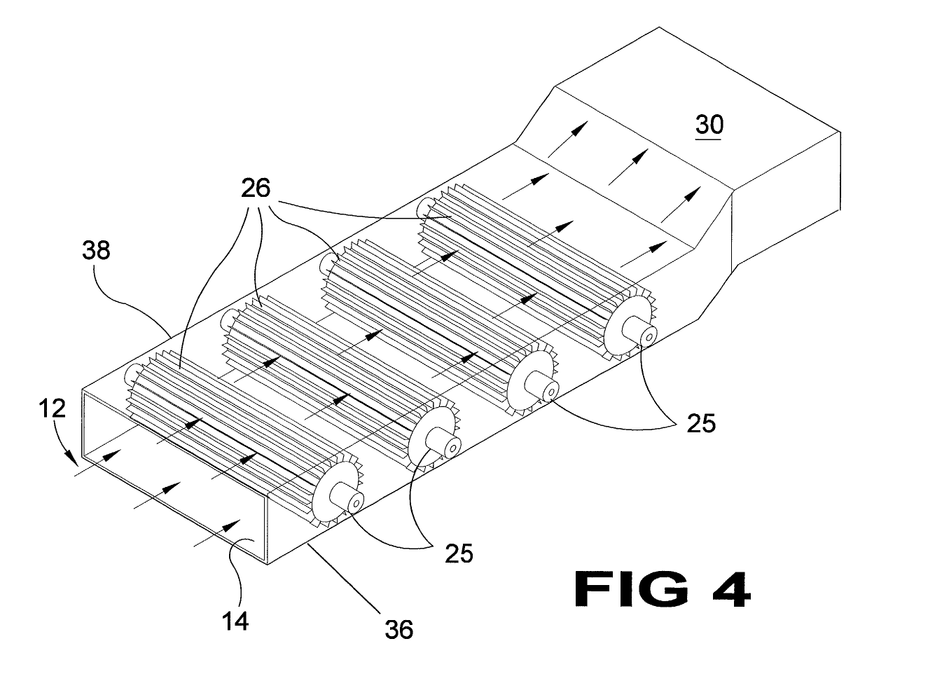

Turning to FIG. 4, shown therein is a perspective view of the wind generator system of the present invention illustrating the components and their interaction with one another. Shown therein is the air flow 12 entering the air intake port 14 which enter into the rectangular duct 36 of the wind generator housing 38 having mounted thereon wind generators 25 being of the roll cage style 26 having impellers thereon. Also shown is the electric motor 30.

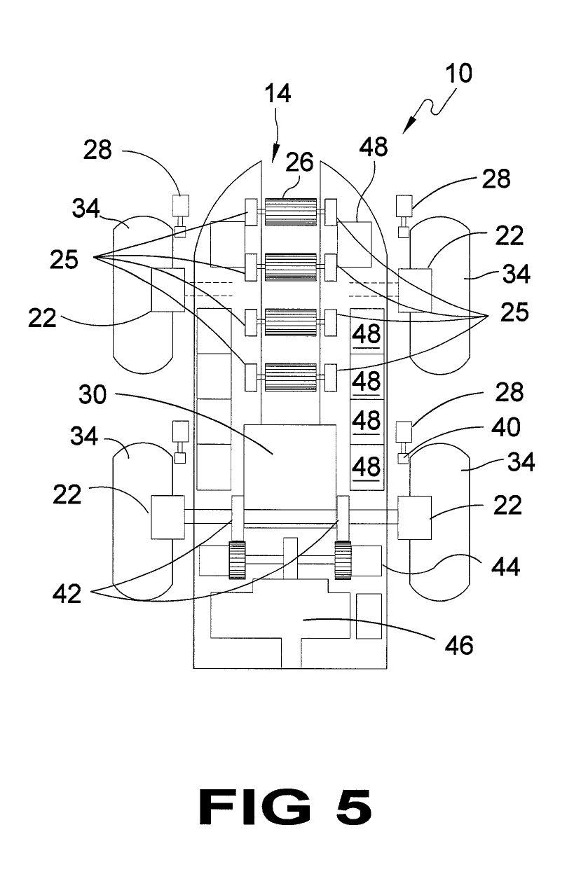

Turning to FIG. 5, shown therein is a diagrammatic top view of the present invention 10 illustrating the placement of the wheel generators 22, wind generators 25, brake activated generator clocks 42, the electrical motor 30 and the emergency steam turbine generator 46. Also shown therein is the air intake port 14 having the roll cage style generator 26 disposed therein having means for connection to the wind generators 25. Also shown are the alternate wheel generator locations 28 having a rotary head 40 thereon for contacting the wheels/tires 34. The wheel generators 22 are also shown thereon. Also shown is the electric motor 30 which is the primary power means along with the brake activated generator clock 42 having brake activated generators 44 mounted thereon. Also shown is the steam turbine 46 which is the emergency recharge power source for the multiple batteries 48.

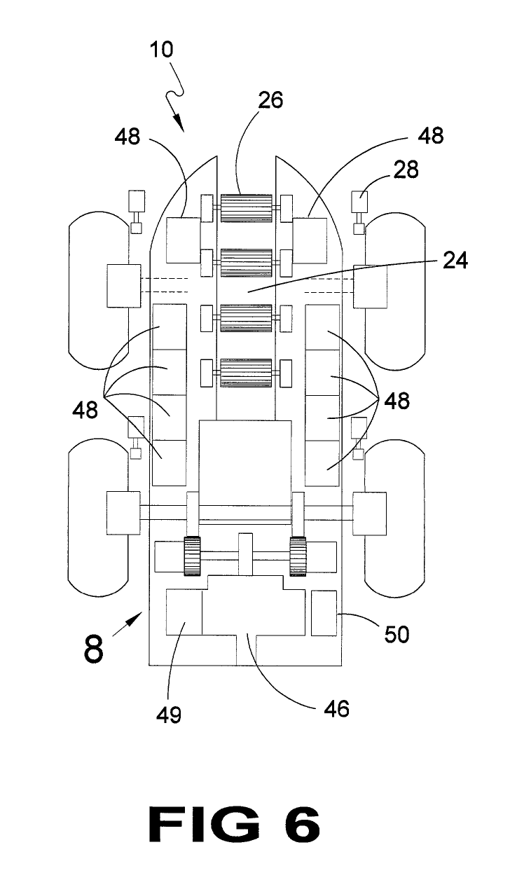

Turning to FIG. 6, shown therein is a diagrammatic side view of the present invention 10 illustrating the placement of the battery banks 48 and the wind generator system. Also shown are the roll cage impellers 26 disposed in the rectangular wind tunnel 24. A plurality of batteries 48 are shown disposed about the vehicle along with the steam turbine engine 46 having a water supply tank 48 and a propane fuel tank 50 associated therewith. Also shown is the alternate wheel generator position 28 as previously disclosed. Other elements previously disclosed are also shown.

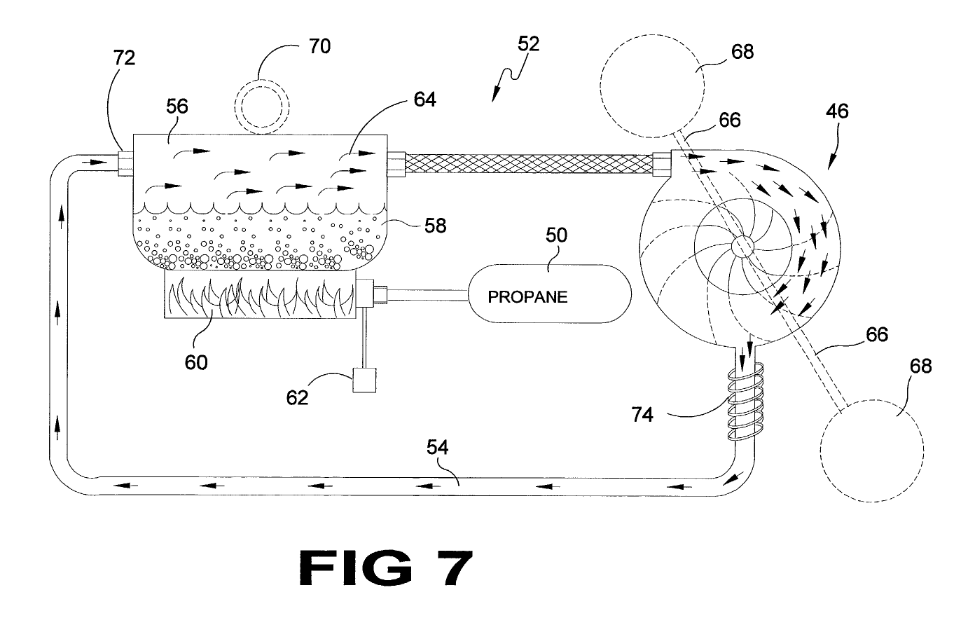

Turning to FIG. 7, shown therein is a diagrammatic side view of the steam turbine generator system 52. Shown therein are conduits 54 for transporting the steam/condensate along with a boiler 56 having water 58 contained therein and a source of heat 60 having an igniter/spark means 62 which uses propane 50 as a fuel source wherein steam 64 is generated, which steam is transported to the steam turbine 46 which has means 66 for communicating with generators 68 which generate electricity. Also shown is a relief valve 70 along with a check valve 72 and a condenser coil 74.

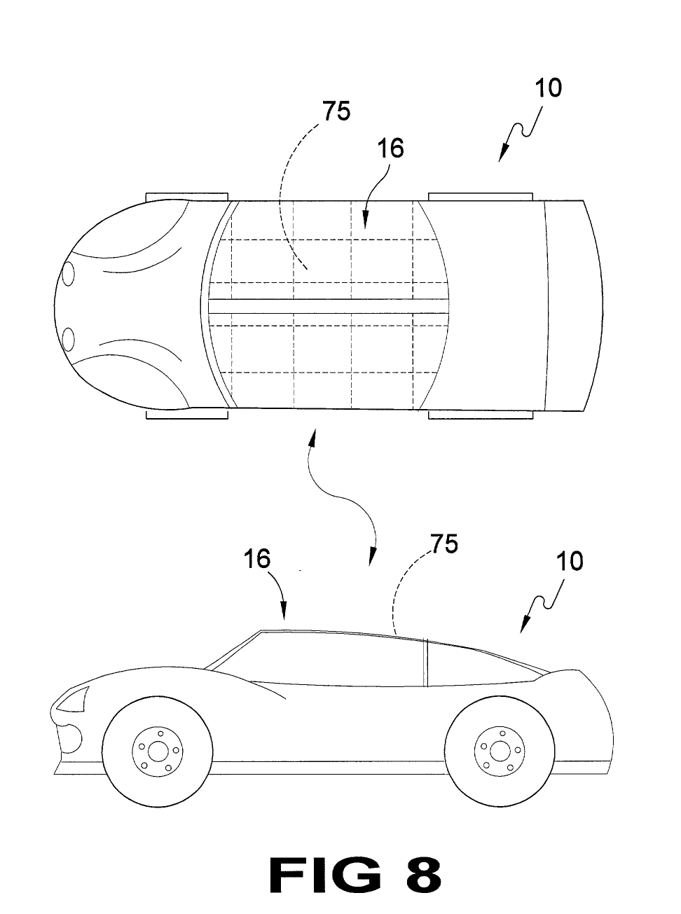

Turning to FIG. 8, shown therein is a top and side view of the present invention 10 showing the solar panel t-tops 16 comprised of solar membranes 75 imbedded in the solar t-top 16.

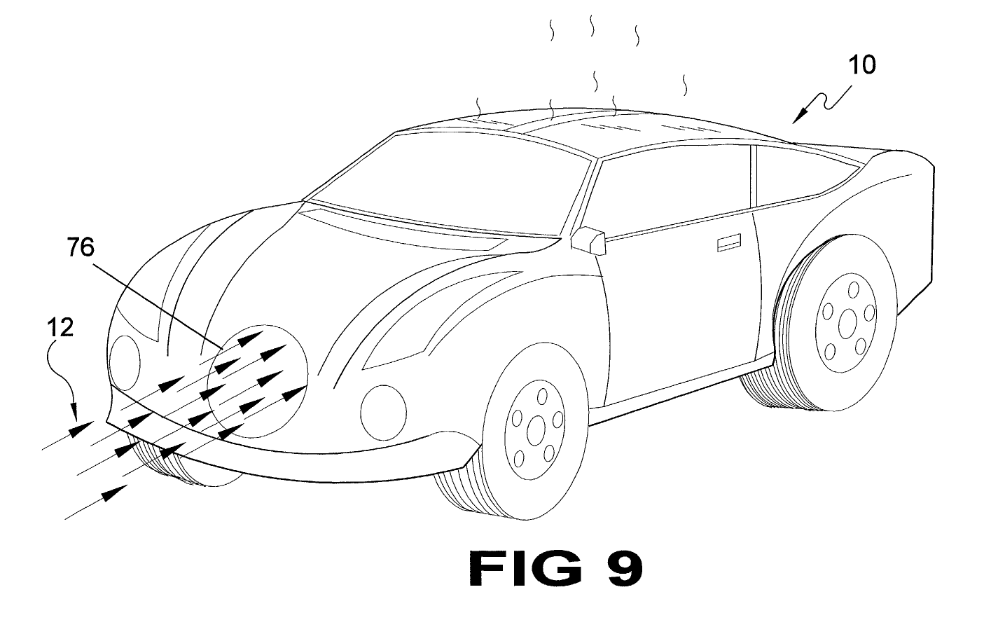

Turning to FIG. 9, shown therein is a perspective view of the present invention 10 having a tubular shaped wind tunnel 76 to house round fan-type impellers.

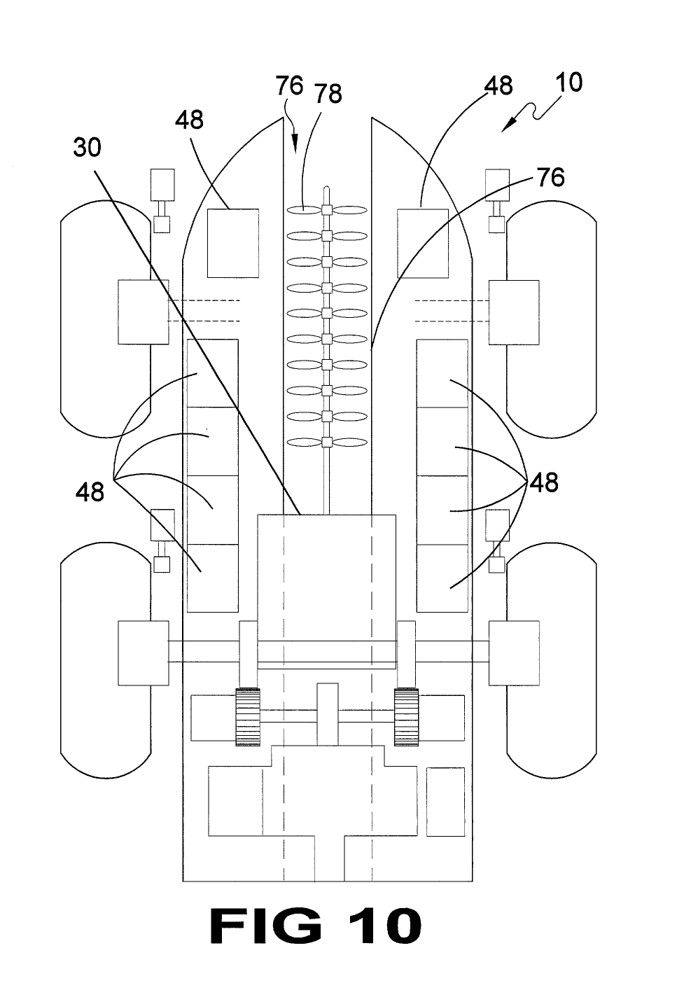

Turning to FIG. 10, shown therein is a diagrammatic bottom view of the present invention 10 showing a plurality of fan-type impellers 78 inside a tubular duct 76. Shown therein is the present invention 10 having the tubular duct wind tunnel 76 having fan type impellers 78 shown therein along with motor 30. Also shown are batteries 48.

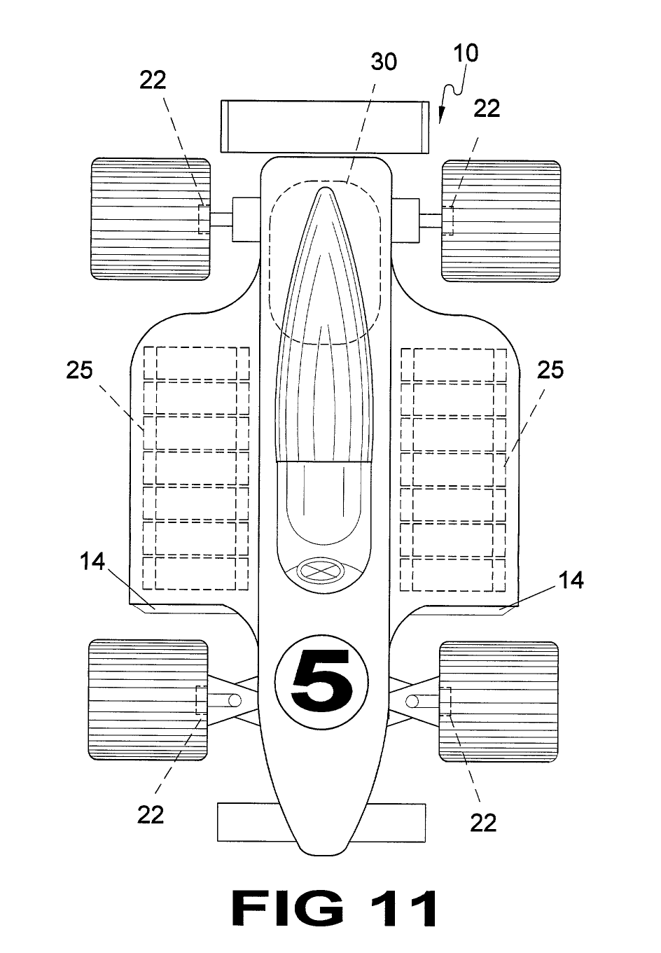

Turning to FIG. 11, shown therein is a top view of the present invention 10 installed in a formula 1 race car using a dual duct roll-cage system. Shown therein installed in the down draft system of the car are a pair of air intake ducts 14 along with a pair of wind turbine generators 25 which utilize the roll cage type wind generators. Also shown are multiple wheel generators 22 along with the electric motor 30 in the rear of the Formula 1 racing car of the present invention 10.

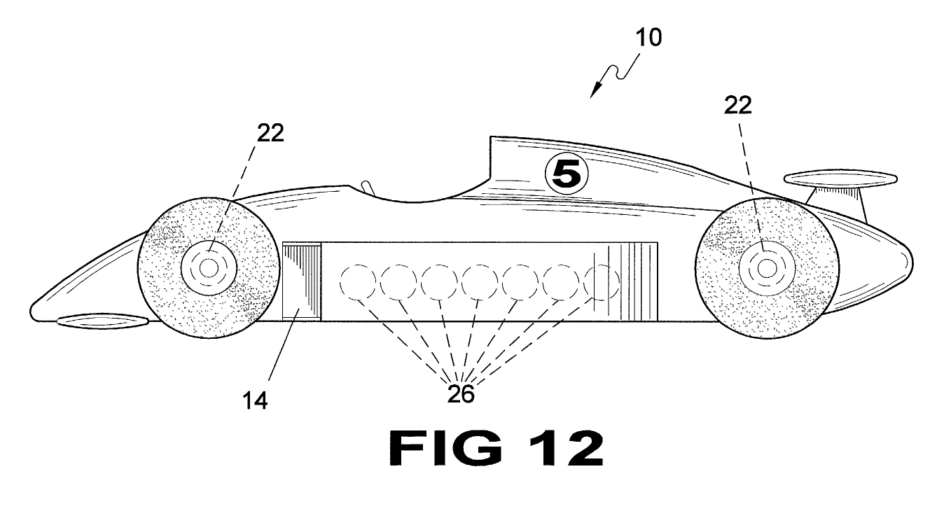

Turning to FIG. 12, shown therein is a top view of the present invention 10 installed in a formula 1 race car using a dual duct roll-cage system. Shown are the multiple roll cage impellers 26 along with air intake port 14 and the multiple wheel generators.

What is claimed to be new and desired to be protected by letters patent is set forth in the appended claims.

I claim:

1. An apparatus for providing multiple auxiliary electric power sources to an electrically powered automobile, the automobile having four wheels having brakes thereon along with a chassis mounted thereon, comprising:
a) a wind tunnel extending through the chassis of the automobile from front to rear, said wind tunnel having an inlet and an outlet;
b) a wind generator disposed in said wind tunnel;
c) a roof disposed on the automobile;
d) means for a solar generator disposed in said roof;
e) means for a wheel generator disposed in cooperation with the wheels of the automobile;
f) means for a steam turbine generator disposed internal the automobile;
g) means for a brake activated generator;
h) an electric motor disposed in the automobile which serves as the primary power source of the automobile; and,
i) means for a battery electrical source for furnishing electricity to the automobile, said battery source being recharged by the auxiliary electric power sources.

2. The apparatus of claim 1, wherein said wind tunnel is rectangular shaped.

3. The apparatus of claim 1, wherein said wind tunnel is tubular shaped.

4. The apparatus of claim 2, wherein said wind generator further comprises a plurality of roll cage impellers, said impellers having means for connection to said wind generator.

5. The apparatus of claim 3, wherein said wind generator further comprises a plurality of fan blade impellers, said impellers having means for connection to said wind generator.

6. The apparatus of claim 1, wherein said means for a solar generator further comprises a solar membrane disposed in said roof.

7. The apparatus of claim 1, wherein said means for a wheel generator further comprises means for communication with the wheels of the automobile.

8. The apparatus of claim 7, said wheels further comprising hubs, said means for a wheel generator further comprising means for communication with said hubs.

9. The apparatus of claim 7, wherein said means for a wheel generator further comprises a rotary head, said rotary head communicating with the wheels so that said rotary head is turned by the wheels, said rotary head thereby turning said wheel generator.

10. The apparatus of claim 1, wherein said steam turbine generator further comprises a boiler having water therein, a means to fire said boiler, a conduit for transporting steam, and a rotary steam turbine engine.

11. The apparatus of claim 10, wherein said rotary steam turbine engine further comprises means for connection to a generator.

12. The apparatus of claim 11, said electric motor disposed in said wind tunnel so that said motor can be air cooled.

13. The apparatus of claim 1, wherein said means for a brake activated generator further comprises means for communicating with the brakes of the automobile whereby electricity is generated through the braking mechanism for the automobile.

14. An apparatus for providing multiple auxiliary electric power sources to an electrically powered Formula 1 race automobile, the automobile having four wheels having brakes thereon along with a chassis mounted thereon, the chassis having a down draft system thereon, comprising:
a) a pair of wind tunnels extending through the chassis of the automobile from front to rear, said wind tunnel having an inlet and an outlet, said wind tunnel disposed in the sides of the automobile in cooperation with the down draft system;
b) a wind generator disposed in said pair of wind tunnels;
c) means for wheel generator disposed in cooperation with the wheels of the automobile;
d) means for a brake activated generator;
e) an electric motor disposed in the automobile which serves as the primary power source of the automobile; and,
f) means for a battery electrical source for furnishing electricity to the automobile, said battery source being recharged by the auxiliary electric power sources.

15. The apparatus of claim 14, wherein said wind tunnel is rectangular shaped.

16. The apparatus of claim 15, wherein said wind generator further comprises a plurality of roll cage impellers, said impellers having means for connection to said wind generator.

17. The apparatus of claim 14, wherein said means for a wheel generator further comprises means for communication with the wheels of the automobile.

18. The apparatus of claim 17, said wheels further comprising hubs, said means for a wheel generator further comprising means for communication with said hubs.

19. The apparatus of claim 14, wherein said means for a brake activated generator further comprises means for communicating with the brakes of the automobile whereby electricity is generated through the braking mechanism for the automobile.
